(19) United States
(12) Patent Application Publication
(10) Pub. No.: US 2007/0116844 A1
(43) Pub. Date: May 24, 2007

(54) Method for manufacturing rice flour having good rheological and sensory characteristics, rice flour produced by the same methods and instant rice soup comprising the rice flour

(75) Inventors: Hyun-Jun Park, Busan (KR); Tea-Keon Ahn, Seoul (KR)

Correspondence Address: MEDLEN & CARROLL, LLP, 101 HOWARD STREET, SUITE 350, SAN FRANCISCO, CA, 94105, US

(73) Assignee: CJ Corp., Seoul (KR)

(21) Appl. No.: 11/511,827

(22) Filed: Aug. 29, 2006

(30) Foreign Application Priority Data
Aug. 31, 2005 (KR) 10-2005-0080874

(51) Int. Cl. A21D 10/00

(52) U.S. Cl. 426/549

(57) ABSTRACT

Disclosed are a method of preparing rice flour having good rheological and sensory characteristics, rice flour prepared by the method, and instant rice soup including the rice flour. Specifically, there are provided a method of preparing rice flour, which has better Theological characteristics, higher material stability through killing of microorganisms during its processing, and much better taste by removal of characteristic odor of rice flour, compared to conventional rice flours or rice flours prepared by other processing methods, and also instant rice soup using the rice flour thus prepared. The rice flour of this invention may be cooked within a short time of 1 min or less through only the addition of warm water (70˜80° C.), and has no unpleasant taste and no characteristic odor occurring from conventional rice flour, thus exhibiting good sensory characteristics for instant foods. As well, since such rice flour has good texture, it may be applied to various foods requiring particular Theological characteristics.

### BACKGROUND OF THE INVENTION

1. Field of the Invention

The present invention relates, generally, to a method of preparing rice flour having good Theological and sensory characteristics, rice flour prepared by the method, and instant rice soup comprising the rice flour. More particularly, the present invention relates to a method of preparing rice flour, which has better Theological characteristics, higher material stability through the killing of microorganisms during its processing, and much better taste due to the removal of characteristic odor of rice flour, compared to conventional rice flours or rice flours prepared by other processing methods, and to instant rice soup using the rice flour thus prepared.

2. Description of the Related Art

In general, a kernel of unpolished brown rice consists of a rice bran layer, including pericarp, testa, and an aleuron layer, and an embryo constituting the small part of the base of rice grain, with the balance being an endosperm. As such, the endosperm is composed mainly of starch and thus corresponds to the part which is edible as fully-milled white rice.

Rice is milled in the form of rice flour depending on necessary purposes and is thus used in the preparation of rice cake, rice porridge, or thin rice gruel, in addition to boiled rice. However, rice, which is a starchy food, has disadvantages in its use in that added heat and water are required for almost every process of preparation. This fact may be easily confirmed in the food culture of Korea, adopting rice as the staple food. For example, boiled rice requires a cooking process, and rice cake requires steaming at a high temperature. In addition, rice porridge or thin rice gruel may be eaten by adding a sufficient amount of water to rice and then essentially applying heat to the rice mixed with water to gelatinize the starchy components thereof.

Moreover, rice is receiving international attention according to recent consumer tendencies toward purchase of healthful foods, foods which are convenient to prepare, and foods which are the result of fusion of domestic traditional foods and foreign foods, as well as ongoing trade disputes related to the rice market opening. Further, research into the development of processed foods using rice flour has been directed toward the characteristics of rice using typical rice flour preparation methods or physically simple rice milling methods, and thus only the inherent properties of rice are mainly under study. Therefore, additional research or commercialization of rice is restricted, and ultimately, limitations are imposed on the development of products suitable for various current requirements of consumers.

In order to fulfill the demands of consumers mentioned above, rice flour having good Theological properties and taste must be developed to be suitable for new purposes, and as well, the probability of realizing such rice flour in the form of a specific product should be considered.

Many instant food products, which are essential to the lifestyles of busy modern people, are presently commercially available. Almost all the instant foods are products originating from foreign eating habits, which include wheat flour as a main material. In foreign countries, since wheat is adopted as the staple food, thorough research into the development of various wheat products has been conducted. On the other hand, in domestic markets, foreign products are being introduced through simple importation or some application.

In the development of various products using wheat, although various attempts have been made to assure the characteristics suitable for necessary purposes, studies related to such attempts have not yet been performed in Korea due to difficult research circumstances. Specifically, no research effort is directed toward methods for instant foods, other than typically known processes, such as hot blast drying, lyophilization, and powdering. According to some domestic research, there has been reported the possibility of development of instant food products having good quality through hot blast drying or lyophilization. However, since such products need additional cooking of 3 min or longer using a heat source, they are not regarded as true instant foods. In particular, instant food products using rice merely include microwavable ready-to-eat boiled rice products, rice porridge or sauce, and hence the quality of products is not enough to satisfy the increasingly fastidious requirements of consumers.

In this regard, research into instant food focusing on food convenience is exemplified as follows.

Korean Patent Laid-open Publication No. 10-1995-2634 discloses a method of preparing instant porridge mainly using cereal material obtained by immersing cereal in a warm water bath at 70±20° C. for 0.5˜5 hours to gelatinize it and then lyophilizing the gelatinized cereal to control the water content thereof to 2˜5 wt %.

Korean Patent Laid-open Publication No. 10-1997-19911 discloses a method of preparing instant pumpkin soup, comprising distributing old pumpkin powder and cereal flour using a power distributor (90˜150° C.) for 0.5˜3 hours and then mixing the distributed material with another material.

Korean Patent Laid-open Publication No. 10-1998-65336 discloses a method of preparing instant food of scorched part of boiled rice, comprising hot air drying the water content of scorched part of boiled rice to a range of about 10˜15%, or freeze drying it to a range of about 5% or less, and then milling such rice. In addition, Korean Patent Laid-open Publication No. 10-1994-6493 discloses a method of preparing instant porridge having high solubility, comprising uniformly coating α-corn flour, starch, and rice flour with 10˜60% of a solution of 10% Arabia gum using a Hobart mixer, drying the coating using a pneumatic dryer at 70˜100° C., and then sifting it through a screen of about 60 mesh.

Korean Patent Laid-open Publication No. 10-1989-4626 discloses a method of preparing instant porridge, comprising loading 100 parts by weight of a mixture of rice flour, medium wheat flour and salt and 17˜23 parts by weight of water into a double compression mold to be compacted, and cutting and drying it.

In this way, although techniques for developing instant foods using cereals are known, specific technological advantages thereof do not approach the desired expectations. Specifically, in the case of material milled after being dried through hot air drying or steaming, cereal, in particular, rice, is not uniformly gelatinized therethrough, and thus it is difficult to acquire desired cooking characteristics without direct application of a heat source. Further, upon the hot air drying, the taste of rice is worsened due to the change of color or generation of undesired characteristic odor. On the other hand, although the freeze dying process is advantageous because water may rapidly infiltrate into cereal within a short time upon cooking thanks to porous physical structure of the cereal, it additionally requires a pre-heating process, such as steaming, in order to realize the gelatinization of starch, undesirably causing the same problems as hot air drying or steaming mentioned above. As well, two preparation processes are required, and hence, personnel expenses and facility costs are increased and productivity is decreased, leading to excessively increased preparation costs.

In addition, according to some studies, in instant porridge prepared using rice flour which is gelatinized using an extruder, the properties of the rice flour have been positively exhibited, desirably suggesting the availability of rice flour. However, unlike actual other cereals, since rice has a very simple taste and is practically tasteless and odorless, it may put off a characteristic odor upon the gelatinization process through extrusion. Hence, when such rice is applied to general-processed foods, functional quality thereof is remarkably decreased. Consequently, it is impossible to apply such rice material in practice.

### SUMMARY OF THE INVENTION

Leading to the present invention, intensive and thorough research into preparation of rice flour having predetermined Theological characteristics, carried out by the present inventors aiming to avoid the problems of properties, quality, techniques and preparation processes encountered through conventional methods in the related art, led to the development of a method of preparing rice flour for instant foods, which can exhibit better characteristics and functional taste and can raise stability to microorganisms at the same time, thus contributing to development of new processed rice products in domestic rice markets, and improving peoples' health and domestic agricultural economy and developing various foods through application of rice to conventional wheat products.

Accordingly, an object of the present invention is to provide a method of preparing rice flour for instant foods, which enables the complete cooking thereof within 1 min using only warm water at 70˜80° C. by means of a general water purifier so as to exhibit properties such as roux of cream soup, conserves functional characteristics superior to other rice flours, and raises stability to microorganisms, leading to a wide range of potential applications therefor.

Another object of the present invention is to provide rice flour prepared by the above method, having good Theological characteristics and improved taste, and instant rice soup comprising the rice flour.

According to one aspect, the present invention provides a method of preparing rice flour for instant foods, comprising 1) preparing mixing water containing salt, and mixing rice material with the mixing water, 2) tempering the rice material mixed with the mixing water in step 1) at 50° C. or less, 3) gelatinizing the rice material obtained in step 2) through extrusion, and 4) milling the gelatinized material and sorting it.

In the present invention, the term “instant food” denotes food to be prepared using hot water or a water bath or through addition of water or milk, as food which may be easily cooked within a short time, may be conveniently stored or kept, may be easily transported and is portable.

In the present invention, the term “rice material” denotes rice used in the preparation of rice flour for instant foods, which includes, but is not limited to, white rice, black rice, nonglutinous rice, and glutinous rice. Preferably, rice material of the present invention includes rice having 10˜16% water.

According to another aspect, the present invention provides a method of preparing rice flour for instant foods, comprising preparing washed high-quality rice material having 10˜16% water, preparing mixing water by adding salt to a concentration of 1˜5 wt % to purified water, adding the mixing water to the prepared rice material in an amount of 3˜15 wt % based on 100 wt % of the rice material to mix them, tempering the rice mixed with water at 10˜50° C. for 1˜5 hours, gelatinizing the tempered rice using an extruder, milling the gelatinized rice, and sorting it.

In the present invention, the term “mixing water” denotes water obtained by dissolving 1˜5 wt % refined salt in edible purified water.

In the above method, although the amount of mixing water may be controlled by those skilled in the art, the mixing water is used in an amount of 3˜15 wt %, based on 100 wt % of the rice material. Further, it is preferred that the mixing water be used immediately after being prepared. In this way, when the mixing water is added, water content suitable for extrusion of the rice material may be maintained and also the water content of rice flour finally obtained through the extrusion process may be controlled within a predetermined range.

In the present invention, the tempering process is conducted by uniformly adding the mixing water to the rice material at 50° C. or less, and preferably 10˜50° C., stirring the rice and water so as to achieve entirely uniform water infiltration, and storing the stirred rice in a storage tank for 1˜5 hours. In the tempering process, since binding of rice grains may occur due to rapid absorption of surface water, a stirring process should be performed several times for 10 min each.

Thereafter, the rice material thus tempered is subjected to an extrusion process to gelatinize it. As such, the extrusion process is carried out using a single-screw extruder at 60˜200 rpm under a temperature condition outside the extruder ranging from 100 to 200° C., and preferably from 120 to 150° C. In such a case, the extrusion of the rice material begins after extrusion process conditions are appropriately set using corn or brown rice.

The extruded product is automatically cut to a predetermined size, rapidly cooled using a high-speed fan and transported into a storage tank to store it. The extruder usable in the present invention is preferably exemplified by a single-screw extruder in the interest of process control.

Subsequently, the milling process is conducted such that a final average particle size is about 80˜200 mesh and final water content is 10% or less, and preferably 5˜10%, followed by collecting a product having a predetermined size through a multistage shifter. In this case, water content is determined by drying the product in an oven at 105° C. for 3 hours or longer, cooling it to room temperature in a desiccator and then measuring the weight thereof. The collected product must be stored through double packaging in order to prevent solidification or generation of condensed water due to absorption of external water.

### BRIEF DESCRIPTION OF THE DRAWING

FIG. 1 is a flowchart schematically showing the process of preparing rice flour for instant foods, according to the present invention.

### DESCRIPTION OF THE PREFERRED EMBODIMENTS

Hereinafter, a detailed description will be given of the present invention, with reference to the appended drawing.

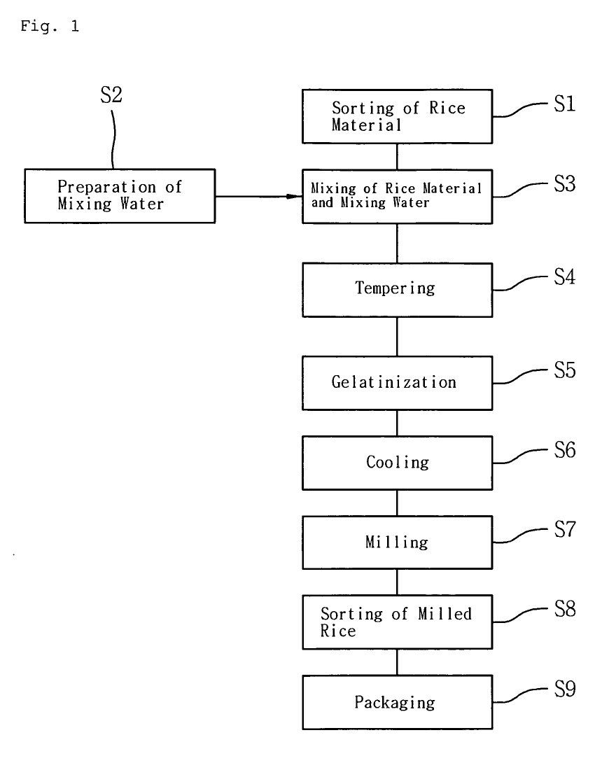

FIG. 1 schematically illustrates the process of preparing rice flour having good rheological characteristics, according to the present invention. As shown in FIG. 1, the method of the present invention proceeds from a material sorting process (S1) for ensuring high-quality rice material having 10˜16% water without impurities, but such a sorting process is not essential for acquiring necessary properties and functional characteristics according to the method of the present invention.

The rice material thus sorted is stored in a discrete place, and a mixing water preparation process (S2) is separately performed. The mixing water is prepared by dissolving 1˜5 wt % refined salt in edible purified water, and is used in an amount of 3˜15 wt %, based on 100 wt % of the rice material. As such, when the excess salt is added to the purified water, it is difficult to remove the characteristic odor caused upon a subsequent gelatinization process. As well, functional quality of actual products may be deteriorated due to the use of excess salt.

The raw material and the mixing water thus separately prepared are subjected to a mixing process (S3) so as to mix the mixing water and the raw material at a uniform ratio.

Thereafter, in a tempering process (S4), the raw material mixed with the mixing water is maintained at 50° C. or less, and preferably at 10˜50° C. for 1˜5 hours, such that the mixing water uniformly infiltrates into the raw material. As such, binding of rice grains may be generated and thus undesirably solidified because of transfer of water from the surface of the rice material to the inner portion thereof or of surface water evaporation. Therefore, during the tempering process, a stirring process is preferably conducted several times for 10 min each.

Since a gelatinization process (S5) greatly affects the Theological characteristics of the rice flour and may result in low quality and unpleasant odors due to excessive heat depending on process conditions to be set, the gelatinization process must be conducted according to previously set conditions. In the gelatinization process, an extrusion process is performed using a single-screw extruder at a speed of 60˜200 rpm at a temperature outside the extruder ranging from 100 to 150° C. With the goal of setting initial extruder conditions, it is preferred that such conditions be adjusted using corn or brown rice and then the desired product be prepared.

The extruded rice material is automatically cut to a suitable size, rapidly cooled using a high-speed fan, and transported to a storage tank to store it (S6). In the tank, the product is allowed to cool to a temperature of 50° C. or less.

In a milling process (S7), a variety of general milling. machines, such as a hammer mill, a jet mill, a ball mill, and/or a rod mill may be used without limit of its type. In such a case, however, there is required a procedure for maximizing the yield so as to control the average particle size of rice flour resulting from the particle sorting process (S8) to 80˜200 mesh depending on the properties of respective machines. The rice flour thus prepared has 5˜10% water.

Subsequently, a packaging process (S9) is conducted such that a difference in temperature between the prepared rice flour and external air falls in a range of less than 10° C. while preventing generation of condensed water due to vapor condensation using double packaging paper. In addition, the generation of condensed water in the packaging paper may cause proliferation of microorganisms, undesirably decreasing the total availability of the product.

The rice flour prepared using the above method has higher water solubility index and water absorption index and lower final viscosity, a setback value and a paste temperature than rice flour obtained by conventional methods. Further, the rice flour of the present invention is observed to have very low crystallinity from the point of view of its structural characteristics. The setback value is obtained by the difference between viscosity upon gelatinization of starch and viscosity upon aging thereof. As the setback value decreases, uniform properties may be exhibited despite the rapid temperature change before and after instant cooking. Such indexes act as standards capable of judging whether the resultant rice flour may be applied to instant soup. Consequently, the rice flour of the present invention is proven to have the properties suitable for use in instant food.

The rice flour prepared by the method of the present invention has viscosity and properties suitable for production of instant foods able to be completely cooked within about 1 min through only the addition of warm water at 70˜80° C., and also has a soft texture unlike general rice flour. In addition, the rice flour of the present invention has no characteristic odor and no taste occurring upon the gelatinization process, unlike rice flours prepared by conventional methods. Ultimately, when the rice flour of the present invention is applied to a product, superior functional quality may be assured.

Therefore, the rice flour of the present invention, which is usable instead of wheat flour, can be prepared into instant soup along with seasonings, and further, can be widely applied to materials for processed foods requiring respective other Theological characteristics.

A better understanding of the present invention may be obtained in light of the following examples which are set forth to illustrate, but are not to be construed to limit the present invention.

### EXAMPLE 1

Nonglutinous white rice having 10˜6% water, serving as rice material, was sorted to remove impurities.

Separately, salt was dissolved in edible purified water, thus preparing mixing water containing 2 wt % salt. The mixing water was uniformly added to the prepared rice material in an amount of 10 wt % based on 100 wt % of the rice material, after which the mixed rice material was tempered under a dark condition of 10˜50° C. for 3 hours. As such, a stirring process was conducted several times for 10 min each so as to prevent binding of rice material due to the mixing of mixing water and rice material.

The tempered material was gelatinized using an extruder, and preferably, a single-screw extruder. In this case, the screw speed was 100˜200 rpm and the temperature outside the extruder was 120˜150° C. In order to improve performance of the extruder, final extrusion conditions were set using starchy material having a husk, such as corn or brown rice.

The extruded product was cut, cooled using a high-speed fan, transported into a storage tank and thus stored. The material in the storage tank was allowed to cool to 50° C. or less, milled to have an average particle size of 100˜150 mesh using a hammer mill or a jet mill, and then sorted using a grain sorting machine, thus preparing a product having final water content of 10% or less.

The product was packaged using double packaging paper to prevent absorption of water.

Using the rice flour thus prepared as a main material, potage type western soup was manufactured without the use of wheat flour.

### EXAMPLE 2

Glutinous white rice having 14% water was sorted to remove impurities.

Separately, salt was dissolved in edible purified water, thus preparing mixing water having 2 wt % salt. The mixing water was uniformly added to the prepared rice material in an amount of 10 wt % based on 100 wt % of the rice material, after which the rice material was tempered under a dark condition of 10˜50° C. for 3 hours. As such, a stirring process was conducted several times for 10 min each so as to prevent binding of rice grains due to the mixing of mixing water and rice material.

The tempered material was gelatinized using a single-screw extruder. As such, the screw speed was 100˜200 rpm and the temperature outside the extruder was 120˜150° C. In order to improve performance of the extruder, final extrusion conditions were set using starch material having a husk, such as corn or brown rice.

The extruded product was cut, cooled using a high-speed fan, transported into a storage tank and thus stored. The material in the storage tank was allowed to cool to 50° C. or less, milled to have an average particle size of 100˜150 mesh using a hammer mill or a jet mill, and then sorted using a particle sorting machine, thus preparing rice flour having a final water content of 10% or less.

The product was packaged using double packaging paper to prevent absorption of water.

### TEST EXAMPLE

Analysis of Characteristics of Rice Flour

The rice flour of Example 1, general rice flour prepared by a conventional method, roasted rice flour, and steamed rice flour were measured with respect to water, pH, WSI (water solubility index), WAI (water absorption index), a coloring index, a particle size, and damaged starch. The results are shown in Table 1 below.

As is apparent from Table 1, it has been confirmed that the rice flour of Example 1 has higher WSI and WAI than the other rice flours to be suitable for a cooking procedure requiring a short cooking time.

TABLE 1

| | | | | Roasted | Steamed |
|---|---|---|---|---|---|
| | | | General Rice | Rice | Rice |
| | | Ex. 1 | Flour | Flour | Flour |
| Water (%) | | 7.77 | 8.5 | 3.6 | 8.58 |
| pH | | 6.31 | 6.51 | 6.29 | 6.74 |
| WSI (%) | | 24.29 | 2.19 | 0.03 | 1.31 |
| WAI | | 4.64 | 1.60 | 2.67 | 3.04 |
| Color Degree | L | 92.33 | 88.39 | 89.35 | 91.24 |
| | a | −0.42 | 0.96 | −0.30 | −0.48 |
| | b | 4.46 | 9.94 | 7.07 | 5.80 |
| Particle Size | Average | 78.73 | 51.17 | 103 | 62.9 |
| (μm) | 90% | 145.0 | 128 | 202.9 | 130 |

| | | | | |
|---|---|---|---|---|
| Damaged Starch (UCD) | 33.5 | 24.3 | 33.2 | 30.9 |

Evaluation of Gelatinization Characteristics

The gelatinization characteristics of the rice flour of Example 1 and the conventional rice flours were evaluated. As the results, the rice flour of the present invention has been proven to have superior Theological characteristics to conventional rice flours, thanks to lower final viscosity, a setback value, and a paste temperature thereof.

The results are shown in Table 2 below.

TABLE 2

| | | General | Roasted | Steamed |
|---|---|---|---|---|
| | Ex. 1 | Rice Flour | Rice Flour | Rice Flour |
| Max. Viscosity (RVU) | 14.08 | 95.17 | 12.83 | 38.08 |
| Stabilized Viscosity(RVU) | 6.92 | 56.58 | 9.25 | 34.5 |
| Viscosity Difference (Max. | 7.17 | 38.58 | 3.58 | 3.58 |
| Visco. − Stabilized Visco.) | | | | |
| Final Viscosity (RVU) | 13.58 | 154.25 | 27.42 | 98.25 |
| Setback Value | 6.67 | 97.67 | 18.14 | 63.75 |
| Paste Temp. (° C.) | 25.6 | 90.03 | 25.05 | 54.5 |

Evaluation of Structural Characteristics

The structural characteristics of the rice flour of Example 1 and the conventional rice flours were evaluated. As the result, the rice flour of the present invention is measured to have much lower crystallinity than the other samples. Thus, when the rice flour of the present invention is applied to actual products, it may be cooked at a lower temperature and desired properties may be exhibited, thereby manifesting superior Theological characteristics to the conventional rice flours.

The results are shown in Table 3 below. In Table 3, crystallinity was measured using X-ray diffraction.

TABLE 3

| | | General Rice | Roasted Rice | Steamed Rice |
|---|---|---|---|---|
| | Ex. 1 | Flour | Flour | Flour |
| Relative | 18.39 | 34.7 | 29.55 | 28.72 |
| Crystallinity (%) | | | | |
| Relative Crystal | 1 | 0.85 | 0.53 | 0.82 |
| Ratio | | | | |

Evaluation of Actual Soup

An instant soup product was prepared using 30% rice flour of Example 1 as a main material and then functionally evaluated by 46 test subjects. For functional evaluation, a numerical standard was determined to be a scale of from 1 to 5, and test items including overall taste were scored. As the result of evaluation of the overall taste, potato soup prepared using the rice flour of the present invention was judged to be 3.9 and mushroom soup prepared using the rice flour of the present invention to be 3.7. From this, it can be seen that the samples using the rice flour of the present invention are superior in functional qualities to those of general rice flour samples.

The results are shown in Table 4 below. In Table 4, the number in brackets represents the proportion of test subjects reporting the highest two grades.

TABLE 4

| | | Mushroom Soup | Mushroom Soup |
|---|---|---|---|
| | Potato Soup using | using Rice | using General |
| Test Menu | Rice Flour of Ex. 1 | Flour of Ex. 1 | Rice Flour |
| Overall | 3.9 (73.9%) | 3.7 (67.4%) | 2.5 (17.2%) |
| Taste | | | |
| Outer | 3.8 (69.6%) | 3.5 (58.7%) | 3.5 (56.9%) |
| Appearance | | | |
| Flavor | 3.9 (65.2%) | 3.5 (54.3%) | 2.8 (21.5%) |
| Texture | 3.6 (56.5%) | 3.2 (43.5%) | 2.4 (45.6%) |
| Aftertaste | 3.9 (71.7%) | 3.7 (67.4%) | 3.0 (40.1%) |

As described hereinbefore, the present invention provides a method of preparing rice flour having Theological and sensory characteristics, rice flour prepared by the method, and instant rice soup comprising the rice flour. The rice flour prepared according to the method of the present invention has superior Theological characteristics to generally milled rice flours and rice flours prepared through a conventional gelatinization process.

Unlike conventional rice flours, the rice flour for instant foods of the present invention exhibits excellent properties capable of being easily completely cooked within 1 min using warm water at 70˜80° C. without an additional complicated cooking procedure such as a boiling process or a simmering process. Further, drawbacks caused by the use of conventional rice flour, that is, problems responsible for negative evaluation results upon use of a product due to inherent odor of rice or characteristic odor thereof in the gelatinization process, may be completely solved. Therefore, in the present invention, rice is used as a new food material, and thus conventional instant foods (soup, porridge or sauce) composed mainly of wheat flour may be replaced.

Moreover, according to the present invention, while the probability of commercializing the rice soup in the field of instant soup is suggested, the new field of rice soup that has not yet been developed to date is opened up to correspond to recent tendency of international consumers who importantly consider health or social interest for rice and to fulfill the demand of consumers who continuously require food convenience. In addition, it is possible to broaden the area of rice processing industries and to realize the development thereof based on new rice processing techniques, therefore resulting in far-reaching effects on various food industries and societies.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preparing rice flour for instant foods, comprising:
1) preparing mixing water containing salt, and mixing rice material with the mixing water;
2) tempering the rice material mixed with the mixing water in step 1) at a temperature of 50° C. or less;
3) extruding the rice material obtained in step 2) to gelatinize it; and
4) milling the gelatinized material and sorting it.

2. The method as set forth in claim 1, wherein the mixing water in step 1) contains 1˜5 wt % salt.

3. The method as set forth in claim 1, wherein the mixing water is used in an amount of 3˜15 wt % based on 100 wt % of the rice material.

4. The method as set forth in claim 1, wherein the tempering in step 2) is conducted at 10˜50° C. for 1˜5 hours.

5. The method as set forth in claim 1, wherein the extruding in step 3) is conducted at a screw speed of an extruder of 60˜200 rpm at a temperature outside the extruder ranging from 100 to 150° C.

6. Rice flour, prepared using the method of any one of claims 1 to 5.

7. Rice soup, comprising rice flour prepared using the method of any one of claims 1 to 5.
